(19) United States
(12) Patent Application Publication
(10) Pub. No.: US 2016/0172931 A1
(43) Pub. Date: Jun. 16, 2016

(54) Alternator rotor to stator integrated hrdrodynamic bearing

(71) Applicants: Joseph Michael Teets, Hobe Sound, FL (US); Jon William Teets, Scottsdale, AZ (US)

(72) Inventors: Joseph Michael Teets, Hobe Sound, FL (US); Jon William Teets, Scottsdale, AZ (US)

(21) Appl. No.: 14/544,233

(22) Filed: Dec. 11, 2014

(51) Int. Cl. H02K 7/08

(52) U.S. Cl. CPC H02K 7/08

(57) ABSTRACT

A hydrodynamic bearing is incorporated within an alternator electrical generating system and or electric motors having permanent magnet (PM) machine rotors wherein a fluid film bearing is integrated between the rotor assembly outer diameter and the electrical stator assembly inner diameter. The alternator rotor outside diameter is a bearing surface and a static sleeve bearing is positioned inboard of the electrical stator inner diameter, coaxially and central, wherein the static sleeve inner diameter is a bearing surface. An additional select material is incorporated to sleeve bearing inner diameter surface to prevent relative surface damage during none fluid film operating conditions.

A gas pressurized system, incorporated as the fluid means yields improved bearing life, reduced machine axial rotor system length and reduced costs in high speed alternators and or motors applications such as in turbomachinery, alternators for generating electricity, Microturbines, hybrid gas turbine engines removing the need for external bearings.

This application claims benefit of the provisional application Ser. No. 61/963,745 filed Dec. 12, 2013.

### BACKGROUND OF THE INVENTION

1. Field of the Invention

The present invention relates generally to hydrodynamic bearings and more specifically it relates to an alternator rotor integrated bearing for turbomachinery, alternators and or electric motors having permanent magnet machine rotors wherein a hydrodynamic bearing system is incorporated between alternator rotor magnet retention sleeve outer surface and the stator inboard area.

2. Description of the Prior Art

It can be appreciated that hydrodynamic bearings have been in use for years. Typically, hydrodynamic bearings can be found in microturbines with high speed alternators (electrical generators) having permanent magnets, turbo alternators, turbo charges with integrated alternators and electric motors as used in machinery and or turbomachinery.

A problem with conventional hydrodynamic bearings used in current turbo machinery, machinery using electric motors and or alternators having rotor permanent magnets, are external bearings (located outboard of the alternator rotor/stator) such as foil compliant air bearings, magnetic bearings, journal bearings, ball bearings or roller bearings add complexity, increase alternator or motor system size with elevated cost. Another problem with conventional hydrostatic bearings such as ball bearings and or roller bearings they have limited life and therefore related turbomachinery require maintenance intervals for replacement. Foil compliant air bearings (hydrodynamic type bearing) require increased compressor rotor and turbine rotor shroud tip clearances for operation resulting in reduced rotor compressor and turbine rotor component efficiencies. Magnetic bearings require electrical power to operate, yield large turbomachinery rotor radial clearances and are costly; the loss of electrical power could damage related turbomachinery and alternator/stator components. Another problem with conventional hydrodynamic bearings, all external bearings used in alternator rotor applications, if a bearing failure occurs both the alternator rotor and stator become damaged; and furthermore external bearings used to date have rotational shaft power losses due to roller element drag forces and or shaft fluid shear drag forces. This new device, an integrated bearing within an alternator rotor/stator allow for better control of stack-up clearances in turbomachinery applications.

While these devices may be suitable for the particular purpose to which they address, they are not as suitable for turbomachinery and alternators or electric motors having permanent magnet alternator rotors wherein a hydrodynamic bearing system is incorporated between alternator rotor magnet retention sleeve outer surface and the alternator stator inboard area offers longer bearing life and reduced system cost.

In these respects, the alternator rotor hydrodynamic bearing according to the present invention substantially departs from the conventional concepts and designs of the prior art, and in so doing provides an apparatus primarily developed for the purpose of turbomachinery and alternators or electric motors having permanent magnet alternator rotors wherein a hydrodynamic bearing system is incorporated between alternator rotor magnet retention sleeve outer surface and the alternator stator inboard area.

### SUMMARY OF THE INVENTION

In view of the foregoing disadvantages inherent in the known types of hydrodynamic bearing now present in the prior art, the present invention provides a new alternator rotor hydrodynamic bearing construction wherein the same can be utilized for turbomachinery and alternators or electric motors having permanent magnet alternator rotors wherein a hydrodynamic bearing system is incorporated between alternator rotor magnet retention sleeve outer surface and the alternator stator inboard area.

The alternator or motor systems incorporate an internal fluid film bearing with pressurized fluid flow as an improvement over the prior art current external bearings to yield longer bearing life, reduced bearing shaft power loss, and reduced rotor blade tip clearances (for an integrated turbine or compressor rotor) improving turbomachinery component efficiencies.

Permanent magnet (PM) alternator electric motors and electric generators have been used in industry, ground vehicles, aircraft auxiliary electrical power generation, turbomachinery, Microturbines, turbo pumps and turbo alternators for a number of years. Typically the alternator rotor having retained permanent magnet, involves high rotational speeds wherein the magnets are retained by an alternator rotor sleeve incorporating material selection of high strength and without effect to stator stacked laminats inner diameter formed tooth geometry flux generation with the alternator rotating magnets during operation.

The general purpose of the present invention, which will be described subsequently in greater detail, is to provide a new alternator rotor hydrodynamic bearing that has many of the advantages of the hydrodynamic bearing mentioned heretofore and many novel features that result in a new alternator rotor hydrodynamic bearing which is not anticipated, rendered obvious, suggested, or even implied by any of the prior art hydrodynamic, fluid film bearing, either alone or in any combination thereof.

To attain this, the present invention generally comprises: a Stator Sleeve Bearing, an Alternator Rotor Assembly, an Alternator Rotor Retainer, an Alternator Stator Assembly and an Alternator Housing. The Stator Sleeve Bearing is an insertable component within a Alternator Stator Assembly having static bearing surfaces for axial and radial alternator rotor loads with material and radial space considerations. The Alternator Rotor Assembly has a core, at least one extending shaft, permanent magnets and a alternator rotor sleeve to retain the permanent magnets wherein the alternator rotor sleeve outer diameter are bearing surfaces. The Alternator Stator Assembly incorporates stacked laminats with inner diameter tooth configured forms, has wound electrical wire about and thru the laminats external wire leads and coaxially receives the alternator rotor therein. The Alternator Housing contains the alternator stator assembly, the alternator rotor assembly, with hydrodynamic bearings therein for axial and radial alternator rotor forces and stator wire power leads exit the alternator housing. The Rotor Retainer is an end cap connected to the alternator housing, has a static fluid bearing surface, interface retains the alternator rotor assembly, the alternator stator assembly and stator sleeve bearing.

There has thus been outlined, rather broadly, the more important features of the invention in order that the detailed description thereof may be better understood and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a permanent magnet alternator rotor hydrostatic or hydrodynamic bearing (fluid film bearing) that will overcome the shortcomings of the prior art devices. As a hydrostatic bearing means external pressurized fluid flow is supplied for a radial central position of the alternator rotor to the stator inner diameter in preparation for rotational operation the latter of which becomes the hydrodynamic bearing application.

An object of the present invention is to provide an alternator rotor hydrostatic or hydrodynamic bearing for turbomachinery and alternators or electric motors having permanent magnet alternator rotors wherein a fluid film bearing system is incorporated between alternator rotor magnet retention sleeve outer surface and the alternator stator inboard area. The alternator rotor assembly integrates with compressor rotor and or turbine rotor.

Another object is to provide an alternator rotor fluid film bearing that incorporate hydrodynamic bearings for alternator rotor application offering minimum or greatly reduced horsepower losses as experienced in current conventional rotor shaft bearings.

Another object is to provide an alternator rotor fluid film bearing that is located central to the alternator stator wherein the journal sleeve material selection has no magnet flux interferences between the alternator rotor and stator without compromise to the electrical power generation and considers optimized radial gap between the stator inside diameter and the rotor magnet/sleeve outside diameter.

Another object is to provide an alternator rotor fluid film bearing that is incorporated within the alternator stator that offers increased bearing life and removes the need for any alternator rotor external bearings.

Another object is to provide an alternator rotor fluid film bearing that Incorporates a rub tolerant sleeve bearing material that resists wear during emergencies shut downs and possible start-ups periods without fluid flow to the rotor shaft bearing system alternator rotor magnet retention sleeve outside diameter and alternator stator sleeve bearing inside diameter.

Another object is to provide an alternator rotor fluid film bearing that incorporates rub tolerant stator sleeve bearing material of a hydrodynamic bearing within the alternator stator inside diameter to prevent the alternator rotor sleeve outside diameter from contacting the stator inside diameter during external bearing failure such as power loss to a magnetic bearing system.

Another object is to provide an alternator rotor fluid film bearing that incorporates a compliant foil bearing within the alternator stator between the stator and permanent magnet alternator rotor as an axially compact bearing means and if required external thrust bearings.

Another object is to provide an alternator rotor fluid film bearing with a central pressurized fluid supply, channeled to the bearing wherein the discharging fluids prevent related caustic operating atmosphere fluids from contaminating the alternator rotor and or stator assemblies.

Another object is to provide a hydrodynamic bearing co-axial to the alternator stator that allows improved component assembly stack up tolerance improved compressor and turbine rotor to shroud reduced clearance higher performance efficiencies.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTIONS OF THE DRAWINGS

Various other object, features and attendant advantages of the present invention will become full appreciated as the same becomes better understood when considered in conjunction with the accompanying drawings, in which like references and characters designate the same or similar parts throughout the several view, wherein:

FIG. 1, is a ¼ cross sectional view an alternator generator/motor system having one alternator stator assembly with integral fluid film sleeve and thrust bearings.

FIG. 2, is a ¼ cross sectional view of an alternator generator/motor system having two stator assemblies with integral fluid film sleeve and thrust bearings.

FIG. 3, is a ¼ cross sectional view of the alternator generator/motor system having one stator assembly with integral fluid film sleeve bearing.

FIG. 4, is a ¼ cross sectional view of the alternator generator/motor system having two stator assemblies with integral fluid sleeve bearing.

### DESCRIPTION OF THE PREFERRED EMBODIMENT

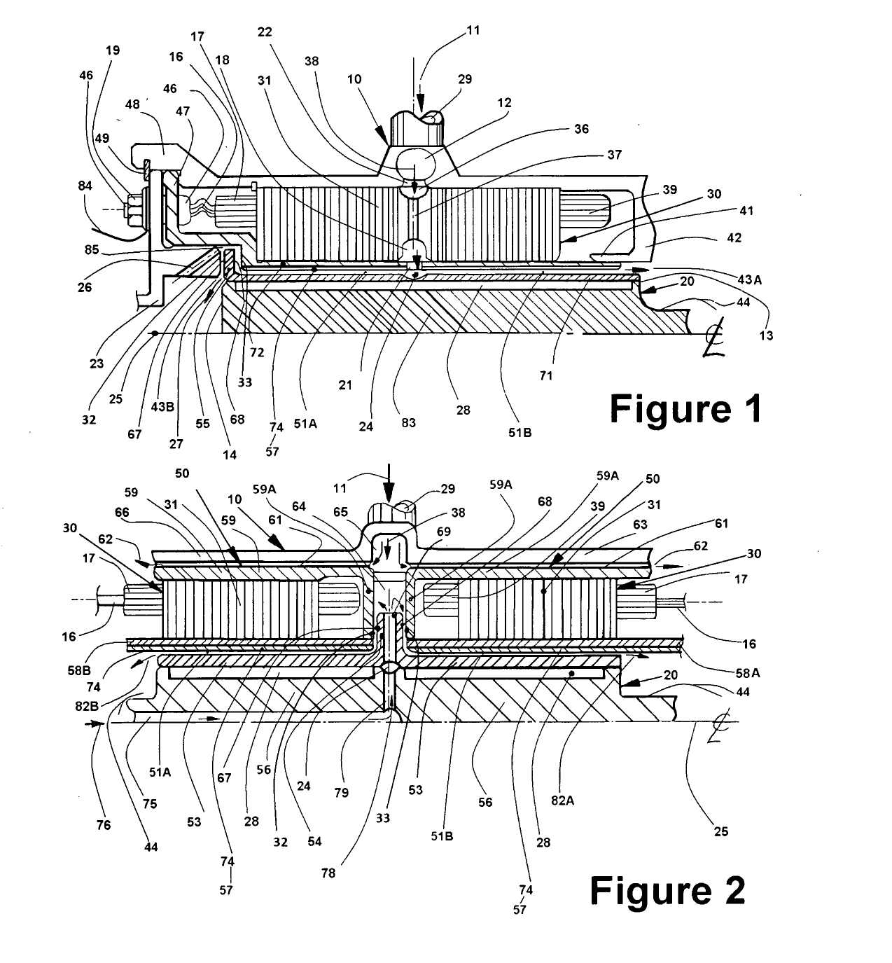

Turning now descriptively to the drawings, in which similar reference characters denote similar elements throughout the several view, the attached figures illustrate a alternator rotor with a hydrodynamic bearing, which comprises a Sleeve Bearing, a Alternator Rotor Assembly, an Alternator Rotor Retainer, an Alternator Stator Assembly and an Alternator Housing. FIG. 1 is the preferred embodiment.

The alternator rotor assembly having permanent magnets incorporates a retention sleeve wherein the outer diameter is a bearing surfaces and if required axial thrust bearing are included for a journal type bearing fluid film bearing. This new bearing invention alternator/motor system incorporates an internal fluid film bearing (pressurized gas) as an improvement over the prior art current external bearings, yielding longer bearing life, simplicity, reduced rotor blade tip clearances for an integrated turbine or compressor rotor, reduced bearing power losses, improved turbomachinery component efficiencies thru reduced blade tip to shroud clearances and improved stack-up assembly clearance calculations.

The invention relates to an alternator for generating electricity or an electric rotor to drive turbomachinery or machinery having permanent magnet retained within the alternator rotor assembly and a fluid film bearing is integrated therein. Considering the preferred embodiment as FIG. 1 the alternator bearing assembly has a static stator sleeve 72 and a rotational bearing (alternator magnet retention means) component the alternator rotor sleeve bearing 71 of alternator rotor assembly 20, is coaxially positioned within the alternator stator assembly 30. The stator sleeve bearing 71 having a material of nonmagnetic quality (example Inconel) and of a longitudinal length thru the stator assembly 30 inner diameter is retained to the alternator housing 10 thru a flange 47 sandwiched between the end cap 23 and the alternator housing 10 outer surface receiving area 48 end of the alternator housing 10 front area proximal end with a retention ring 49 or bolt arrangement; and the distal stator sleeve end is insertable into the aft alternator housing area 41 of alternator housing 10. The inner diameter of the stator sleeve bearing is a bearing surface, has an insertable carbon material 74 or composite material etc. capable of accepting rotor rotational surface forces without damage to alternator rotor sleeve bearing 71 outer surface. The radial thickness of the alternator sleeve bearing sleeve adds to the radial distance between the magnet and the laminat inner diameter tooth form but needs to be minimized in view of magnet 53 strength and subsequent electrical power generation thru the electrical wire 16 from the relative rotation of the alternator rotor assembly 20 magnet 28 past the laminat 31 inner surface tooth forms. Centrally located are radial fluid transfer holes 21 that allow fluid flow 11 from cavities 12, 37 and 17 to transition into the sleeve bearing annular cavity 24 and then downstream thru annular flow bearing surfaces forward flow 51A and aft flow 51B cavities formed between the alternator rotor sleeve bearing outer diameter and the inner diameter of the stator sleeve bearing 72 protective surface 74, 57. The inner diameter of the sleeve bearing 72 or outer diameter of 71 could have integrated surface geometries for bearing tribology considerations—fluid film design requirements. A forward cavity 85 accepts the thrust bearing radial component 55 of the alternator rotor sleeve bearing 71 along with bearing fluid supply from 51A to the thrust bearing 32, 67 and 33,72 fluid flow design requirements with inward discharge fluid flow 27. The alternator rotor assembly 20 has a rotational centerline 25, a core 56 of iron material or equivalent, permanent magnets 83, a rotor magnet retention means alternator sleeve bearing 71 and a minimum of one rotor shaft 44 extending. The shaft end is used as an output motor drive means or as an alternator to generate electricity from an external input rotational load. The alternator rotor assembly 20, load could be thru an integrated turbomachinery compressor rotor or turbine rotor. The alternator magnet retention sleeve bearing 71 outer diameter area as a fluid film bearing is a PM alternator rotor bearing surface with a central bearing fluid supply annular cavity 24 that receives fluid from the outboard stator sleeve fluid supply channels 21. A forward located radial component 55 of the stator sleeve bearing 72 accept rotor thrust loads thru surfaces 33, 68 and 32, 67 aft and forward loads respectively. Forward and aft axial bearing fluid flow channels 51A and 51B are formed between the stator sleeve bearing 72 inner diameter and alternator sleeve bearing 71 outer diameter with exiting fluid flow 43A and 43B the latter discharging the thrust bearing area after passing thru cavity 85 and thrust rotor bearing channeled fluid flow surfaces 67 and 68. Bearing fluid supply can also be thru channels 26 retention cap 23.

The Stator Sleeve Bearing is part of the hydrodynamic fluid bearing system a static bearing member located inboard of the alternator stator assembly having fluid film interface with the alternator rotor sleeve bearing surface outside diameter of the alternator rotor assembly 20. The stator sleeve bearing 72 is of high strength material with nonmagnetic quality (example Inconel) with a longitudinal length thru the stator assembly 30 inner diameter and is retained to the alternator housing 10 thru a flange 47 sandwiched between the end cap 23 and the alternator housing 10 outer receiving area 48 end proximal end with a retention ring 49 or bolt arrangement; and the distal stator sleeve bearing end is insertable into the aft alternator housing area 41 of alternator housing 10. The inner diameter of the stator sleeve bearing is a bearing surface, with an insertable carbon material 74 or composite material etc. capable of accepting rotor rotational surface forces without damage to alternator rotor sleeve bearing 71 surface. The radial thickness of the alternator sleeve bearing sleeve adds to the radial distance between the magnet and the laminat inner diameter tooth form but is minimized via the small bearing design clearances, not to compromise the magnetic flux and subsequent electrical power generation. As an option the radial component 47 of the stator sleeve bearing 72 could be resilient mounted along with the aft sleeve insertion 41/42 into the housing 10 for alternator rotor damper considerations.

The Alternator Stator Assembly, retained in the alternator housing 10, incorporates stacked laminats with inner diameter tooth configured forms, has wound electrical wire about and thru the laminats, external wire leads and coaxially receives the alternator rotor assembly. The outer diameter of the laminat stack is close fitted to the alternator housing such as to remove electrical power generated heat from the laminat stack. An alternator sleeve bearing is positioned to the stator assembly inner diameter that in operation receives an alternator rotor assembly in close proximity and coaxial to the stator inner diameter, wherein relative rotation—alternator magnets to alternator stator inner diameter tooth forms, generate a magnetic flux yielding electricity within the wires in a alternator generation mode. Stator lead wires are thru the stator housing via insulted power lugs then to outboard power electronics to change the high voltage high frequency power to useful electricity. An external bearing fluid supply passes fluid thru the alternator stator inwardly with additional cooling stator means, then to the alternator rotor sleeve bearing surfaces. The main cooling means for the stator is thru the outer diameter close fit to the alternator housing which as a stator assembly is installed into the alternator housing. Additional cooling is thru fluid supply passing inwardly thru the stator assembly in transit to the alternator rotor journal bearing supply.

The Alternator Stator Assembly 30 is insertable to the Alternator Housing and consists of a laminat stack of iron stamped sheet forms 31 having inner diameter tooth forms, wound electrical wire 16 thru the stator laminats, end turns 17 and 39, output leads 16 and output lead terminal 84 with insulated power terminal lugs 46 and retention nuts 84A. The distal end of the stator generally has no output lead just wound wire ends 39 whereas the proximal end has output lead 16 lead wires. The alternator housing 10, supplies fluid flow to the stator assembly, has an axially central bearing fluid flow supply 11 typically gaseous supplied thru the alternator housing 10 outer surface supply tube 29 with fluid passage into an annular manifold 12 then radially inward to a annular channel 36 wherein radial channels 37 within the stator assembly 30 transfer the pressurized gas (fluid) flow 11 to an inner stator annular cavity 18 then again thru the stator sleeve radial channels 21 to the alternator magnet retention/alternator rotor sleeve bearing 71 alternator rotor annular supply 24 for the bearing operation. A stator sleeve bearing 72 in close proximity of the stator assembly has a retention flange 47 retain at the alternator housing 10 proximal end 48 and an aft retention means 41, 42 wherein the end cap 23 the end cap 23 captures the radial bearing sleeve component 55 with forward 67 and aft 68 thrust face bearing interacts with the static bearing surfaces 32, 33. The alternator rotor sleeve bearing 71 thrust bearing radial component 55 with surfaces 67 and 68 could be incorporated to the alternator core 83 forward or aft of the stator or combination thereof.

Depending on the thrust load requirement of the alternator rotor the thrust bearing radial form 55 of the alternator sleeve could be removed leaving a straight alternator rotor sleeve bearing 71 with no thrust bearing surfaces 67 and 68 and or the forward and aft cavities of the alternator could contain a pressure to act on the faces 14, 13 and possible lab seal to the alternator rotor assembly 20 could be incorporated. The rotor retainer or end cap 23 has a bearing fluid drain 27 and a radial surface that is the static bearing surface of the rotation thrust bearing surface 67/68 axially holds the position of the alternator rotor assembly 20.

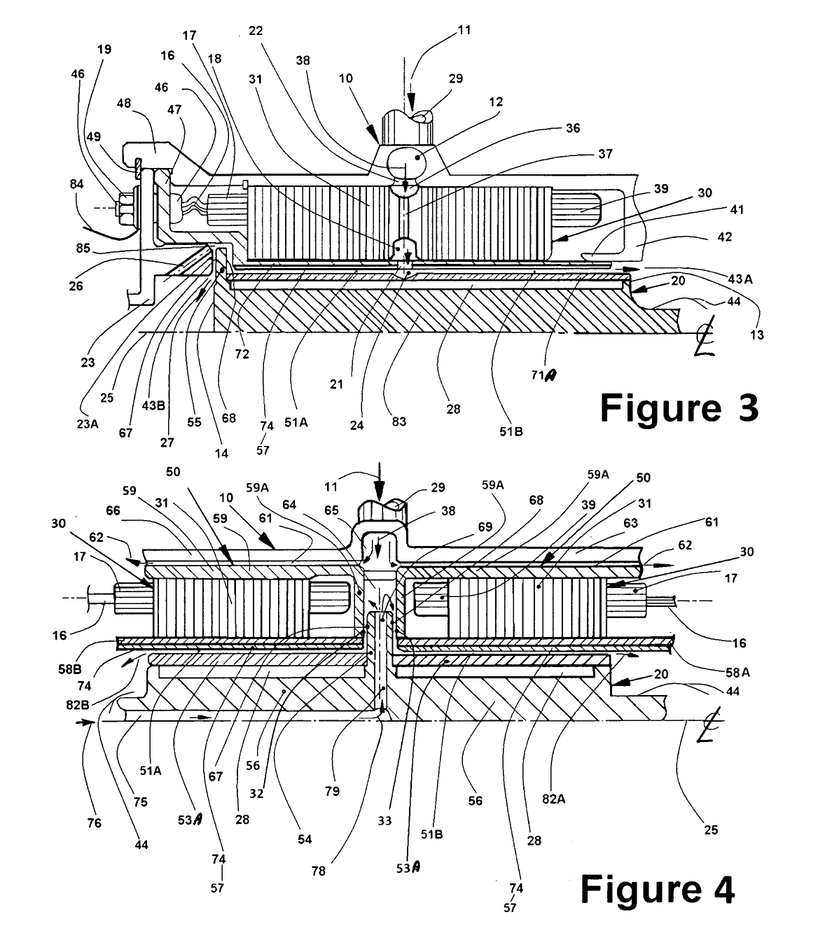

In FIG. 1, axially centrally located are radial fluid transfer holes 21 that allow fluid flow 11 from cavities 12, 37 and 17 to transition into the sleeve bearing annular cavity 24 and then downstream thru annular flow bearing surfaces forward flow 51A and aft flow 51B cavities formed between the alternator rotor sleeve bearing outer diameter and the inner diameter of the stator sleeve bearing 72 protective surface 74, 57. The inner diameter of the sleeve bearing 72 or outer diameter of alternator rotor sleeve bearing 71 could have integrated surface configurations for bearing tribology—fluid film design requirements. A forward cavity 85 receives the thrust bearing radial component 55 of the alternator rotor sleeve bearing 71 along with bearing fluid supply from 51A for the thrust bearing 32, 67 and 33,72 fluid flow design requirements with discharge fluid flow 27. Supplemental supply fluid flow could be thru channel 26. Also, the radial thrust bearing surfaces 67, 68 radial component 55 could be integrated to the alternator rotor core 83 for ease of alternator rotor sleeve bearing manufacture consideration, reference FIG. 3.

The Alternator Rotor Assembly 20 has a rotational centerline 25, a core 56 of iron material or equivalent, permanent magnets 83, a rotor magnet retention means—alternator sleeve bearing 71 and a minimum of one rotor shaft 44 compressor or turbine rotor drive means. The shaft end is used as an output motor drive means or as an alternator to generate electricity from an external input rotational load. The alternator rotor assembly 20, power load could be thru an integrated turbomachinery compressor rotor or turbine rotor. The alternator magnet retention sleeve bearing 71 outer diameter area as a fluid film bearing is a PM alternator rotor bearing surface with a central bearing fluid supply annular cavity 24 that receives fluid from the outboard stator sleeve fluid supply channels 21. A forward located radial component 55 of the stator sleeve bearing 72 accept rotor thrust loads thru surfaces 33, 68 and 32, 67 aft and forward loads respectively. Forward and aft axial bearing fluid flow channels 51A and 51B are formed between the stator sleeve bearing 72 inner diameter and alternator sleeve bearing 71 outer diameter with exiting fluid flow 43A and 43B the latter discharging the thrust bearing area after passing thru cavity 85 and thrust rotor bearing channeled fluid flow thru thrust bearing surfaces 67 and 68.

The Alternator Rotor Assembly 20 has permanent magnets 28, an alternator rotor magnet retention sleeve wherein the outer diameter of the magnet retention sleeve becomes a bearing (fluid film bearing) surface, the alternator rotor sleeve bearing 71, 53. An axial thrust bearing means radial component 55 of 71 alternator rotor sleeve bearing of FIG. 1 also could be integrated to the alternator rotor core 56, 83 reference FIG. 3, 4 to allow ease of simple alternator rotor sleeve bearing manufacture 53A and 71A.

The Alternator Housing 10 with an end cap alternator retainer, retains the alternator stator assembly and the alternator rotor assembly with fluid film bearings therein for axial and radial alternator rotor forces. The alternator housing contains the alternator stator assembly provisions for exiting electrical output wire leads, alternator rotor assembly and stator sleeve bearing retention either ridged mounted or damper mounted to the housing structure.

The alternator housing has a bearing fluid supply channels initiating from the housing outer areas. Also the bearing fluid supply could be from an inboard source interconnecting to the alternator rotor assembly shaft. A rotor fluid pump could be integrated to the alternator rotor as bearing fluid supply means. The alternator housing could receive two stator assemblies to allow use of thrust bearing means located between the stator ends. (Reference FIG. 2, 4)

The Alternator Rotor Retainer is an end cap, attaches to the alternator housing, axially retains/positions the alternator rotor within the stator sleeve bearing and stator assembly and has a thrust bearing surface. The end cap is a means to axially retain the alternator rotor within the alternator housing thru a thrust bearing having that has forward and aft static surfaces about the alternator rotor sleeve bearing radial component as thrust bearing radial surfaces, forward and aft captured between the stator sleeve bearing radial component and the housing end cap. There are bearing fluid supply channels about the thrust bearing for fluid supply and discharge requirements.

The end cap 23 has a static thrust bearing surface 32 and axially retains/positions the alternator rotor sleeve bearing 71 radial component 55 with thrust bearing face surfaces 67, 68. The thrust bearing fluid supply comes from channel 51A into cavity 85 with discharge flow 26 and 27 the latter from channeled surfaces across the thrust bearing surface 32, 67.

### Description of Alternative Embodiments

Fluid flow to the bearings, reference FIG. 2, could be thru a center hole 75 of FIG. 2 radially thru and into the alternator rotor sleeve and stator sleeve assembly to annular channel 24. As yet another configuration, reference FIG. 2, two coaxial alternator stator assemblies 50 could be in place of one stator assembly of FIG. 1 with a thrust bearing location axially central to the alternator rotor sleeve bearing and positioned between the stator assembly ends.

FIG. 2, two stator assemblies 50 are incorporated wherein the magnet retention/alternator rotor sleeve 53 has a radial component 54 (could be integral to the alternator rotor core 56) with forward and aft thrust bearing surfaces 67 and 68 respectively. Bearing supply fluid 76 is thru the center 44 of the alternator rotor core 56 having radial channels 78 and annular fluid feed channel 24 with radial holes 69 thru the alternator rotor radial component supplying bearing fluid to an outboard cavity 64 and subsequent pressurized fluid distribution to the thrust bearing surfaces 67, 68 and the alternator stator sleeve to rotor sleeve annular cavities 51A, 51B bearing requirements with exiting fluid flow 82A and 82B. The alternator stator assembly 50 incorporate an outer cooling sleeve 59 with channeled fluid flow 61 between the alternator housing 63 inner diameter and cooling sleeve 59 outer diameter to remove the laminat electrical power heat generation wherein fluid supply 38 cooling flow 65 removes the stator heat; also as a supplemental fluid flow to cavity 64 for bearing surfaces fluid flow requirements consideration. Radial surfaces 59B of the cooling sleeve 59A interconnect with the stator sleeve bearing 58A and 58B as supports and thrust bearing surface means whereas the axial ends interface with the alternator housing 10 either is a hard mount or damper resilient design scheme wherein the stator sleeve bearing is spaced from the stator inner area. The outboard cooling stator sleeve axial ends of 59B and 59A interface with the housing either as a ridged or damper/resilient design scheme.

In FIG. 2,4 the alternator housing incorporates two stator assemblies 30 with cooling sleeve 59A as 50 assembly yields a thrust bearing, alternator rotor position means located between the stator ends as in FIG. 2, 4.

As another means to axially retain the alternator rotor, the rotor magnet strength interaction—close proximity to the alternator stator iron laminat in itself maintains the axial position of a low thrust load operation or non operation, thus removes the need for a retainer cap/thrust bearing component. As a further thrust bearing means FIG. 1, 3, the alternator surface ends 13, 14 with or without lab seals applied to the alternator rotor assembly core 83, accepts fluid pressure forces therein act solely on the alternator assembly rotor ends for alternator rotor axial positioning.

Also as another means of the alternator rotor thrust control a drive shaft coupling could be incorporated to drive an external compressor rotor or turbine rotor wherein the drive shaft interconnects to the alternator rotor assembly as an external thrust load control.

Yet another means (reference FIG. 2, 4) to retain the alternator rotor is to have a alternator housing 10 retain two axially stacked stator assemblies 50 with radial component 59A, 59A having surfaces 32, 33 interact with surfaces 67, 68 of the alternator rotor sleeve bearing radial component 54. The alternator rotor assembly 20, sleeve bearing 71 radial component 55 of FIG. 1 could be integral to the core 83 as shown in FIG. 3.

The Alternator Housing 10 of FIG. 1, retains the alternator rotor assembly 20 and stator assembly 30 of which create heat during electrical power generation or motor mode wherein a heat removing means is incorporated thru the housing. Stator power leads pass thru the alternator housing, a stator sleeve bearing coaxially within the stator inner diameter, bearing fluid supply channels thru the housing, an alternator rotor having, permanent magnets retained by a alternator sleeve bearing and positioned coaxially, axially central to the stator with a fluid film bearing within and having a minimum of one output/input power shaft extending from the alternator rotor assembly thru alternator housing. A thrust bearing is incorporated into the alternator rotor assembly 20 thru a radial surface component 55, located at one end and is retained by a housing end cap 23. Considering a two alternator stator scheme (FIG. 2, 4) incorporated into the housing, the thrust bearing rotating radial component 54 surfaces 67, 68 of the alternator rotor sleeve bearing 53 are sandwiched between the stator ends having interaction with the stator assembly cooling sleeve 59, end 59A surfaces 32, 33. The stator assemblies 50 incorporate cooling sleeves 59 outer surface heat exchangers having radial inwardly extending structure with surfaces 32, 33 that interact with the alternator rotor sleeve bearing 67, 68 as a thrust bearing means. Bearing fluid supply is from the outer surface of the housing, flow channel 64 cavity between the stator ends 52A wherein the sleeve bearing surfaces receives annular fluid flow 51A, 51B via fluid flow channeled thru the thrust bearing.

As another bearing fluid supply 76, from the cap 23 end, fluid flows thru the alternator rotor center diameter 75, core 56, inner diameter wherein fluid passes thru the alternator rotor centrally then thru radial channels 79, annulus 24 and channels 69 and into cavity 65 with subsequent bearing fluid flow and cooling fluid flow 61 of the cooling sleeve 59. The stator sleeve bearing can be retained to the housing at either end or thru the stator laminat stack 30. Also alternator rotor dampers could be incorporated via resilient stator sleeve support outside of the stator or thru the stator laminat 31 stack.

As another version of this fluid film bearing application within a PM alternator generator system or motor system, the thrust bearings are removed, relying on the magnet strength interaction with the stator laminat stack for the alternator rotor axial positioning within the stator/housing assembly.

Another means of retaining the stator sleeve bearing is to retain the stator sleeve bearing to the housing aft end internally stationary cantilevered from the aft end extending forward such to allow the stator to be insert over the stator sleeve bearing.

As an additional alternative, the alternator stator assembly 30 consists of: a laminat stack of iron stamped sheet forms 31 with inner diameter tooth forms, wound electrical wire 16, external output leads 84 and output lead terminals 46 with retention nuts 84A. The distal end of the stator has no output lead just wound wire 39 whereas the proximal end has output lead 16 inner connected to output terminals 46. The alternator housing 10 as a body has a external bearing fluid 11 typically gaseous form with flow supplied thru the outer surface port 29 and fluid passage into an annular supply manifold 12 then radially inward to a annular channel 12 and radial channels 37, within the stator assembly 30 for fluid transfer thru the pressurized gas (working fluid) to an inner stator annular cavity 18 then again thru the stator sleeve radial channels 21 to the alternator rotor sleeve bearing 71 annular dispersion cavity 24 for the fluid film bearing operation flow cavities 51B and 51A. There are forward flange 47 sleeve retention to housing 10 and an aft means support 42 of the stator sleeve bearing 72 retention means 41 to the housing; the end cap 23 captures the stator sleeve bearing 72 static radial component 47 with a forward 32, 67 and aft 33, 68 thrust bearing means. Also as another scheme the alternator magnet retention sleeve thrust bearing radial component 55 could be incorporated and forward or aft of the stator or combination thereof.

The thrust bearing could be integrated to the alternator core 83 as noted in FIG. 3 allowing simplicity in the manufacturing the alternator rotor sleeve bearing 71 as a straight cylindrical sleeve form 71A. Depending on the thrust load requirement of the alternator rotor the radial components of the alternator sleeve could be removed leaving a straight cylinder form rotor sleeve bearing with no thrust bearing and or the forward cavity and aft cavities of the alternator could contain a pressure to act on the faces surface areas 13, 14 and possible lab seal to the alternator rotor could be used as a fluid sealing means. The rotor retainer or end cap 23 has a radial surface 32 that is the static bearing surface of the thrust bearing surface 67 and in combination with 68, 33 radial surfaces axially holds the position of the alternator rotor assembly 20. The stator assembly 30 is insertable into the housing 10 wherein the stator sleeve bearing 72 positioned within the stator assembly 30 is retained to the alternator housing 10 via radial flange 47 and retaining ring 49 or equivalent. Stator lead wire 16 with insulated lugs 46 is secured to the cap 23 and carries the output electrical power from generated electrical power or input power from an outside source to drive the alternator rotor assembly 20 as a motor. The radial component of the stator sleeve could be resilient mounted along with the aft sleeve insertion 42 into the housing for alternator rotor damper considerations. As an alternative alternator configuration in FIG. 2 two stator assemblies 30 with cooling sleeves 59 as a further assembly 50 is incorporated wherein the alternator magnet retention sleeve becomes alternator rotor sleeve bearing 53 wherein the radial component 54 incorporates forward and aft thrust bearing surfaces 32, 67 and 33, 68 static and rotatable respectively. Bearing supply fluid 76 is thru the center 25, hole 75 of the alternator rotor core 56 with intersecting continued fluid flow radial channels 78 and annular fluid channel 24 and radial holes 69 thru the alternator rotor assembly 20 rotor sleeve bearing 53 radial component 54 yielding bearing fluid to an outboard cavity 64 and subsequent fluid distribution to the thrust bearing surfaces 32, 67 and 33, 68 and the annular alternator rotor/stator sleeve bearing cavity thru fluid flow 51A, 51B requirements with exiting flow 82A and 82B. The stator assemblies 50 incorporate an outboard cooling sleeves 59 to remove the laminat electrical heat generation wherein fluid from cavity 38 supplies cooling channel 61 flow with exiting flow 62 to remove the generated stator heat. Supplemental fluid flow 38 of cavity 65 to cavity 64 for bearing and cooling requirements could be incorporated. Radial structures 59A of the cooling sleeve interconnects with the stator sleeve bearing as supports and thrust bearing surface means. Outboard inner stator sleeve bearing ends 58B and 58A interface with the housing 10. As yet another configuration, FIG. 4 the thrust bearing rotor radial component 54, surface 67, 68 can be integrated to the alternator rotor core 56 allowing a simple cylinder form to retain magnet 28, retention sleeve means the alternator rotor sleeve bearing 53A for ease of manufacture. The alternator rotor assembly 20 having permanent magnets 28 has an alternator rotor magnet retention sleeve wherein the outer diameter of retention sleeve becomes a bearing (fluid film bearing) surface, the alternator rotor sleeve bearing 71, 53. An axial thrust bearing means is integrated/incorporated to this fluid film bearing or integrated to the alternator rotor core 56, 83 reference FIG. 2, 4.

FIG. 1 exhibits a thrust bearing incorporated with the alternator rotor sleeve bearing 71 as a radial surface component 55, located at one end and is retained by a housing end cap 23 with bearing surfaces therein.

FIG. 2 represents a scheme having two alternator stator assemblies 50 within the alternator housing 10 wherein the thrust bearing radial component 54, rotating radial forward and aft surfaces of the alternator rotor sleeve bearing are sandwiched between the alternator stator assembly ends. The thrust bearing radial component 54 could be integrated to the alternator rotor core 56 as noted in FIG. 4. The alternator stator assemblies incorporate outer surface cooling sleeves 59 with radial inboard extending structure 59A having 32, 33 surface that interact with the radial component 54 surfaces 67, 68 as a thrust bearing means. FIG. 2, 4 bearing fluid supply 11 with tube 29, thru the channel 38 and 64 then past 67, 68 thrust bearing radial surface flow with continued flow thru the stator sleeve bearings fluid channels 51A, 51B an annulus between the alternator rotor sleeve bearing 53 outer diameter surfaces and the stator sleeve bearing 58A, 58B inner diameter fluid discharging at 82A and 82B.

In FIG. 2, as another bearing fluid supply means, fluid supply 76 is delivered to and thru the alternator rotor center 75 hole, end intersecting radial flow channels 79 flowing outwardly, 69 into flow annulus 64, for bearing fluid flow dispersion and cooling therein. The stator sleeve bearing (a static detail) can be retained to the housing at either end or thru the stator laminat stack. Also alternator rotor dampers could be incorporated via resilient stator sleeve support outside of the stator or thru the stator laminats. The radial thrust bearing component 54 could be integrated to the alternator rotor core 56 as noted in FIG. 4. FIG. 2 represents a scheme having two alternator stator assemblies 50 within the alternator housing 10 wherein the thrust bearing radial component 54, rotating radial forward and aft surfaces of the alternator rotor sleeve bearing are sandwiched between the alternator stator assembly ends. The thrust bearing radial component 54 could be integrated to the alternator rotor core 56 as noted in FIG. 4. The alternator stator assemblies incorporate outer surface cooling sleeves 59 with radial inboard extending structure 59A having 32, 33 surface that interact with the radial component 54 surfaces 67, 68 as a thrust bearing means. FIG. 2, 4 bearing fluid supply with tube 29, thru the channel 38 and 64 then past 67, 68 thrust bearing radial surface flow with continued flow thru the stator sleeve bearings fluid channels 51A, 51B an annulus between the alternator rotor sleeve bearing 53 outer diameter surfaces and the stator sleeve bearing 58A, 58B inner diameter fluid discharging at 82A and 82B.

In FIG. 2, as another bearing fluid supply means, fluid supply 76 is delivered to and thru the alternator rotor center 75 hole, end intersecting radial flow channels 79 flowing outwardly, 69 into flow annulus 64, for bearing fluid flow dispersion and cooling therein. The stator sleeve bearing (a static detail) can be retained to the housing at either end or thru the stator laminat stack. Also alternator rotor dampers could be incorporated via resilient stator sleeve support outside of the stator or thru the stator laminats. As a note the radial thrust bearing component 54 could be integrated to the alternator rotor core 56 as noted in FIG. 4.

As to further discussion of the manner of usage and operation of the present invention, the same should be apparent from the above description. Accordingly, no further discussion relating the manner of usage and operation will be provided.

With respect to the above description then, it is to be realized that the optimum dimensional relationships fort the parts of the invention, to include variations is size, materials, shape, form, function and manner of operation, assembly and use, are deemed readily apparent and obvious it one skilled in the art, and all equivalent relationships to the those illustrated in the drawings and described in the specification are intended to be encompassed by the present invention.

Therefore, the foregoing is considered as illustrative only of the principles of the invention. Further, since numerous modifications and changes will readily occur to those skilled o in the art, it is not desired to limit the invention to the exact construction and operation shown and described, and accordingly all suitable modifications and equivalents may be resort to, falling within the scope of the invention.

What is claimed is:

1. An electric motor having an alternator rotor assembly and electrical stator assembly with fluid film, hydrodynamic bearings integrated therein, comprising:
an alternator housing;
at least one alternator stator assembly having a laminat stack with inner and outer diameters, wound electrical wire about the laminat stack, coaxially within said alternator housing and housing exiting electrical power lead wires;
a stator sleeve bearing having inner and outer diameters, is coaxial and in close proximity to the said alternator stator inner diameter wherein the stator sleeve inner diameter is a bearing surface;
an alternator rotor assembly retained within said alternator housing, coaxial to and in close proximity of said stator sleeve inner diameter, a rotor core, a minimum of one extending shaft from the rotor core, permanent magnets within the rotor core, a magnet retention sleeve having inner and outer diameters wherein the outer diameter is a bearing surface.

2. An electric motor of claim 1 wherein the said fluid film, hydrodynamic bearing receives pressurized gas for operation.

3. An electric motor of claim 1 wherein the said stator sleeve bearing is retained outboard of the stator assembly.

4. An electric motor of claim 1 wherein the said stator sleeve bearing is retained to said alternator stator assembly.

5. An electric motor of claim 1 wherein the said stator sleeve bearing inner diameter has an integrated carbon sleeve.

6. An electric motor of claim 1 wherein the said stator assembly is retained within an outboard cooling wherein a minimum of one end supports the said stator sleeve bearing.

7. An electric motor of claim 1 wherein the said alternator rotor assembly, rotor core, has a radial extending integral ring component thrust bearing face surfaces, adjacent to a least one said alternator sleeve bearing, where radial holes channel rotor core inner fluid supply outwardly to an outer bearing fluid flow distribution chamber.

8. An electric motor of claim 1 wherein the said alternator rotor assembly having a alternator rotor core extended shaft a compressor rotor is integrated therein.

9. An alternator electric generator system having an alternator rotor assembly, an electrical stator assembly with fluid film bearings integrated therein, comprising:
an alternator housing;
a minimum one alternator stator assembly having a laminat stack with inner and outer diameters, wound electrical wire about the laminat stack, coaxially in close proximity within said alternator housing and housing exiting electrical power lead wires;
a stator sleeve bearing having inner and outer diameters, is coaxial and in close proximity to the said alternator stator inner diameter wherein the stator sleeve inner diameter is a bearing surface;
an alternator rotor assembly coaxial to and in close proximity of said stator sleeve inner diameter, a alternator rotor core, a minimum of one extending rotor shaft from the alternator rotor core, permanent magnets within the rotor core, a magnet retention sleeve having inner and outer diameters wherein the outer diameter is a bearing surface.

10. An alternator electric generator of claim 9 wherein the said fluid film bearing operates with pressurized gas.

11. An alternator electric generator of claim 9 wherein the said stator sleeve bearing is alternator housing retained outboard of the stator assembly.

12. An alternator electric generator of claim 9 wherein the said stator sleeve bearing is retained to said alternator stator assembly.

13. An alternator electric generator of claim 9 wherein the said stator sleeve bearing inner diameter has an integrated carbon sleeve.

14. An alternator electric generator of claim 9 wherein the said stator assembly is retained within an outboard cooling wherein a minimum of one end supports the said stator sleeve bearing.

15. An alternator electric generator of claim 9 wherein the said alternator rotor assembly, rotor core has a coaxial radial extending ring component with external face thrust bearing surfaces, adjacent to a least one said alternator sleeve bearing, where the radial holes channel rotor core inner fluid supply outwardly to an outer bearing fluid flow distribution chamber.

16. An alternator electric generator of claim 9 wherein said the alternator core extended shaft end has an integrated turbine rotor.
